(19) United States
(12) Patent Application Publication
(10) Pub. No.: US 2010/0047377 A1
(43) Pub. Date: Feb. 25, 2010

(54) MOLDING MACHINE

(75) Inventors: SONG-ZHANG JIANG, Shenzhen City (CN); HAN-HUNG LI, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO. LTD., Shenzhen City (CN); HON HAI PRECISION INDUSTRY CO., LTD., Tu-Cheng (TW)

(21) Appl. No.: 12/339,056

(22) Filed: Dec. 19, 2008

(30) Foreign Application Priority Data
Aug. 19, 2008 (CN) 200810304046.7

(51) Int. Cl. B29C 45/16

(52) U.S. Cl. 425/122

(57) ABSTRACT

A molding machine for in-mold-decoration using a film includes a female mold, a male mold capable of engaging with the female mold, and a moving member. The moving member is mounted between the male mold and the female mold. The moving member defines a plurality of cooling passages for coolant flowing therethrough to cool the moving member. The male mold is capable of being moved to resist against the female mold with the moving member being sandwiched therebetween. The female mold, the male mold, and the moving member bound to form a molding space for molding articles.

### BACKGROUND

1. Technical Field

The present disclosure relates to molding machines and, particularly, to a molding machine for producing molded articles.

2. Description of Related Art

Generally, in molding articles, the molded articles are often required to be molded with an ornamental coat laid in molding machines. Referring to FIG. 1, such a molding machine normally includes a female mold 106, a male mold 108, and a feeder 102 configured for providing a film 104 having an ornamental design coat between the female mold 106 and the male mold 108. The female mold 106 defines a cavity 110 in a first side thereof facing the male mold 108, and two exhaust holes 112 communicating with the cavity 110 for vacuumizing the cavity 110. A protrusion 114 extends from the male mold 108 toward the female mold 106, for engaging with the cavity 110. The male mold 108 defines an injection hole 116 communicating with the cavity 110. In injection molding, the film 104 is contacted to a sidewall of the cavity 110 when the cavity 110 is vacuumized via a pump (not shown) through the exhaust holes 112, and molten molded material is injected into the cavity 110 via the injection hole 116, to form a molded article having the ornamental design left by the film 104. Therefore, the thicker the molded article is to be, the deeper the cavity 110 must be. However, if the cavity 110 is too deep, the film 104 may be overly stretched to contact the sidewall of the cavity 110, resulting in tearing the film 104. As a result, the ornamental design on the molded article may be damaged.

### BRIEF DESCRIPTION OF THE DRAWINGS

FIG. 1 is a schematic diagram of a related-art molding machine.

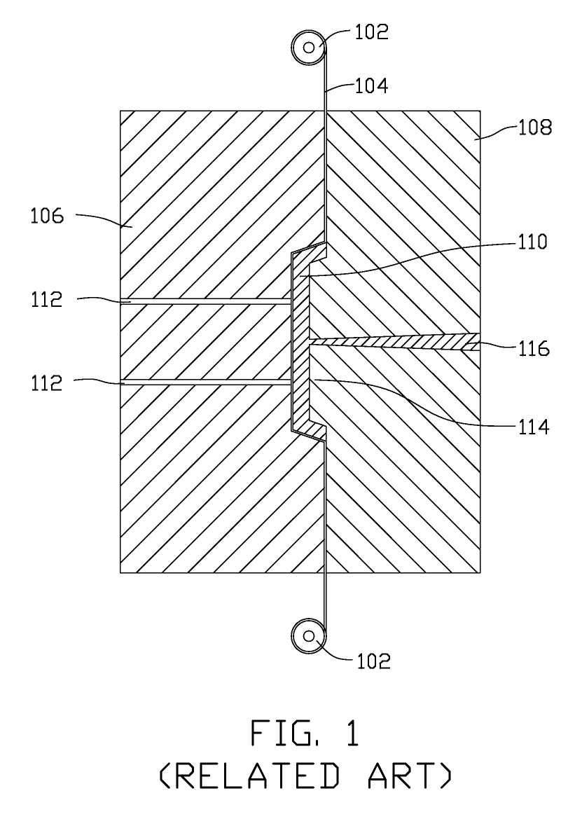

FIG. 2 is a cross-sectional, schematic diagram of a first exemplary embodiment of a molding machine.

FIG. 3 is similar to FIG. 2, and showing a working state of the molding machine.

FIG. 4 is a cross-sectional, schematic diagram of a second exemplary embodiment of a molding machine, showing a working state of the molding machine.

### DETAILED DESCRIPTION

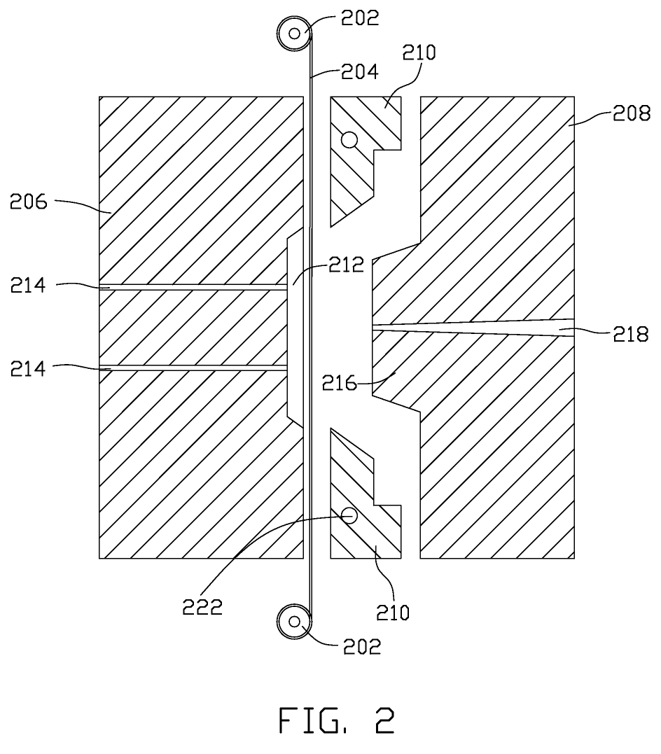

Referring to FIG. 2, a first embodiment of a molding machine is used to mold articles (not shown) each having an ornamental design coat. The molding machine includes a film 204, a feeder 202 feeding the film 204, a female mold 206, a male mold 208 facing and engaging with the female mold 206, and a moving member 210.

The film 204 has an ornamental design coat (not shown) according to the requirement for a molded article, and the ornamental design coat can be detached from the film 204 to cover a surface of the molded article. The feeder 202 is capable of placing the film 204 between the male mold 208 and the female mold 206.

The female mold 206 defines a cavity 212 in a first surface of the female mold 206 facing the male mold 208, and two exhaust holes 214 communicating with the cavity 212. The exhaust holes 214 are parallel to each other, and transversely defined through a sidewall of the cavity 212 to a second surface of the female mold 206 opposite to the first surface. An end of each exhaust hole 214 positioned at the second surface is connected to a pump (not shown) for vacuumizing the cavity 212.

The male mold 208 includes a first side facing the first surface of the female mold 206, and a second side opposite to the first side. A protrusion portion 216 extends from the first side of the male mold 208 for engaging with the cavity 212. The male mold 208 defines an injection hole 218 transversely defined through the protrusion 216 to the second side of the male mold 208.

The moving member 210 defines a plurality of cooling passages 222 for passage of coolant, such as cold water, flowing therethrough to quickly cool the moving member 210, which avoids thermal expansion of the moving member 210. The moving member 210 is detachably mounted to the first side of the male mold 208, and configured for pressing the film 204 against and fix it to the first surface of the female mold 206. In one embodiment, the moving member 210 may be mounted to the male mold 208 by a coil spring (not shown).

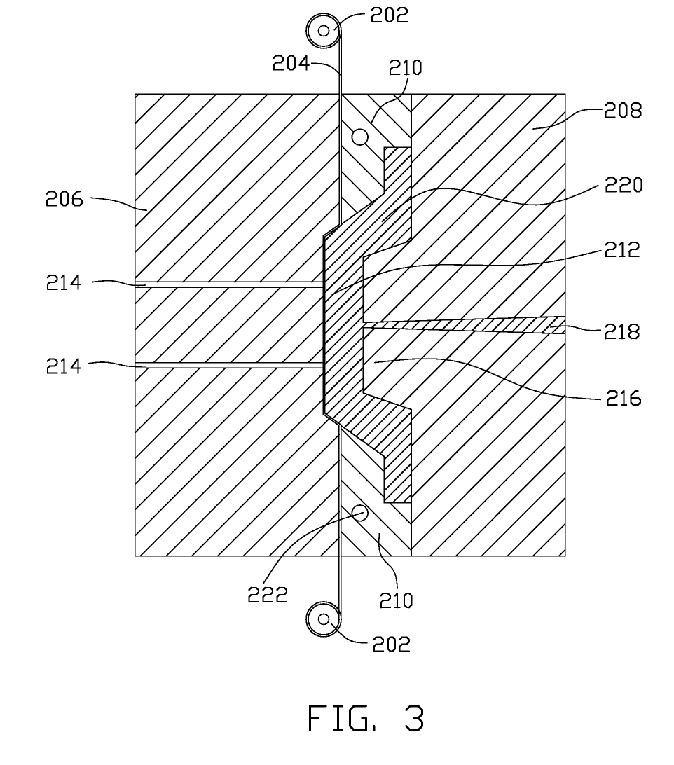

Referring to FIG. 3, in use, the feeder 202 places the film 204 between the female mold 206 and the male mold 208, with the ornamental design coat facing the male mold 208. The male mold 208 and the moving member 210 are moved towards the female mold 206 until the moving member 210 firmly resists against the first surface of the female mold 206. Correspondingly, the male mold 208 resists against the moving member 210, resulting in a molding space 220 that is bounded by the cavity 212, the moving member 210, and the first side of the male mold 208. The film 204 is sandwiched between the female mold 206 and the moving member 210, with a part being received in the molding space 220. The molding space 220 is vacuumized via the exhaust holes 214, therefore a surface of the film 204 opposite to the ornamental design coat is fully contacted against the sidewall of the cavity 212.

In the above-mentioned description, obviously, a depth of the molding space 220 is mostly determined by the thickness of the moving member 210 between the female mold 206 and the male mold 208. Therefore, a moving member having an appropriate thickness can be chosen according to a thickness of the molded article, and then mounted between the male mold 208 and the female mold 206, to adjust the depth of the molding space 220. As a result, the film 204 is stretched only as much as a depth of the cavity 212, no matter how thick the molded article is to be.

Molten plastic material is injected into the cavity 212 via the injection hole 218, until the molding space 220 is full.

After injection, the molding machine will be cooled, and the male mold 208 can then be removed from the female mold 206, together with the moving member 210. Therefore, the molded article is obtained, and can be taken from the cavity 212, with the ornamental design coat of the film 204 being fully adhered to the molded article.

The feeder 202 feeds the film 204 out of the cavity 212, with the coolant flowing in the cooling passages 222 to quickly cool the moving member 210, to prepare for a next molding process.

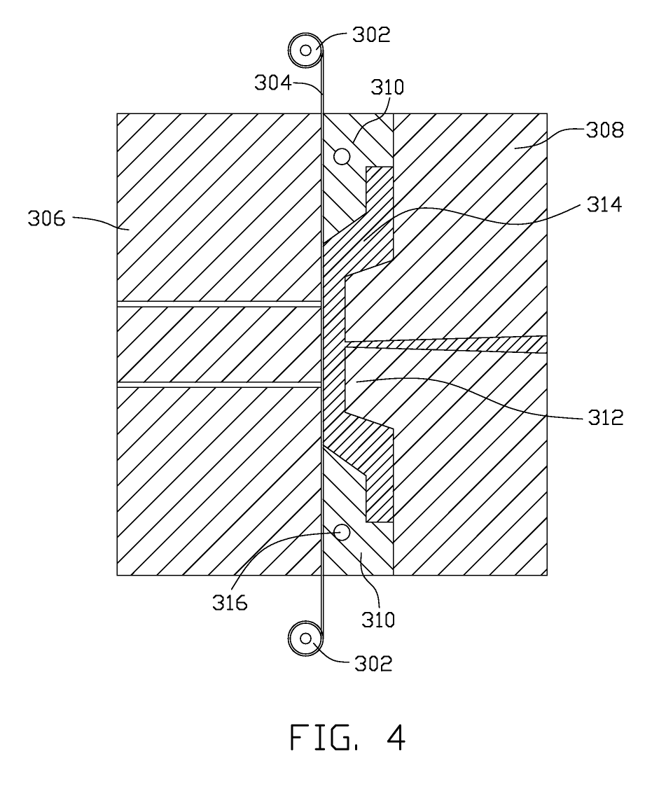

Referring to FIG. 4, a second embodiment of a molding machine, as shown, is similar to that of the first embodiment. The second embodiment includes a feeder 302, a film 304, a moving member 310, a female mold 306 including a first side wall, and a male mold 308 including a protrusion 312 facing the first sidewall of the female mold 306. The moving member 310 defines a plurality of cooling passages 316. A difference is that, the molding space 314 is bounded by the first side wall of the female mold 306, the moving member 310, and the male mold 308. Therefore, in a molding process, the film 304 can be directly contacted to the first side wall of the female mold 306.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments.

What is claimed is:

1. A molding machine for in-mold-decoration using a film, comprising:
a female mold;
a male mold capable of engaging with the female mold;
a moving member mounted between the male mold and the female mold, the moving member defining a plurality of cooling passages for coolant flowing therethrough to cool the moving member;
wherein the male mold is capable of being moved to resist against the female mold with the moving member being sandwiched therebetween; the female mold, the male mold, and the moving member bound to form a molding space for molding articles.

2. The molding machine of claim 1, further comprising a feeder capable of feeding the film positioned between the female mold and the male mold, wherein the moving member can be moved to the female mold to press the film to firmly contact the female mol.

3. The molding machine of claim 1, further comprising a feeder for feeding the film, wherein the feeder is configured to feed the film between the female mold and the moving member.

4. The molding machine of claim 1, wherein the female mold defines a cavity to form part of the molding space, a protrusion extends from the male mold for engaged with the cavity, the protrusion is received in the molding space.

5. The molding machine of claim 4, wherein an injection hole is transversely defined in the male mold, and passed through the protrusion to communicate with the molding space.

6. The molding machine of claim 4, wherein the female mold transversely defines two exhaust holes communicating with the cavity.

7. The molding machine of claim 1, wherein an injection hole is transversely defined in the male mold to communicate with the molding space.
